(19) United States
(12) Patent Application Publication
(10) Pub. No.: US 2023/0162104 A1
(43) Pub. Date: May 25, 2023

(54) ASSIGNING TRANSPORTATION ON DEMAND VEHICLES

(71) Applicant: MOOVIT APP GLOBAL LTD., Ness Ziona (IL)

(72) Inventors: Binyamin GALON, Tzur Hadassah (IL); Michael SORANI, Ramat Gan (IL); Nir BEZALEL, Rehovot (IL); Roy BICK, Kfar Saba (IL); Vadim VAKSIN, Rehovot (IL); Doron Nissim TVIZER, Ness Ziona (IL); Noga BARAK, Tel Aviv (IL); Gil Emanuel FUCHS, Ness Ziona (IL)

(21) Appl. No.: 18/101,228

(22) Filed: Jan. 25, 2023

Related U.S. Application Data
(63) Continuation of application No. PCT/IL2021/050894, filed on Jul. 22, 2021.
Application No. PCT/IL2021/050894 is a continuation-in-part of application No. PCT/IL21/50778, filed on Jun. 24, 2021.
Application No. PCT/IL21/50778 is a continuation-in-part of application No. PCT/IL21/50499, filed on Apr. 30, 2021.
(60) Provisional application No. 63/056,640, filed on Jul. 26, 2020.

(51) Int. Cl. G06Q 10/0631

(52) U.S. Cl. CPC G06Q 10/06311

(57) ABSTRACT

Embodiments are provided for managing transportation-on-demand vehicles, including a non-transitory computer-readable medium including instructions that when executed by at least one processor, cause it to perform operations, which may include: determining service need feature vectors for a geographical region of interest, each service need feature vector including components associated with: at least one of a plurality of transportation needs, a transportation time, and a location within the geographical region of interest; identifying at least one cluster including a portion of the service need feature vectors; identifying an associated spatiotemporal zone of interest in the geographical region of interest; deploying at least a portion of the fleet of transportation-on-demand vehicles; tracking locations of the deployed transportation-on-demand vehicles for the identified zones of interest; receiving a request associated with a user location in the zone of interest for a transportation-on-demand vehicle; and selecting one of the deployed transportation-on-demand vehicles.

### RELATED APPLICATIONS

This application claims benefit under 35 U.S.C. 119(e) of U.S. Provisional Application 63/056,640 filed Jul. 26, 2020 and is a Continuation in Part of PCT International Application PCT/IL2021/050499 filed on Apr. 30, 2021 and is a Continuation in Part of PCT International Application PCT/IL2021/050778 filed Jun. 24, 2021, the disclosures of which are incorporated herein by reference.

### FIELD

Embodiments of the disclosure relate to managing vehicle resources to provide a modern population of users with Mobility as a Service (MaaS).

### BACKGROUND

The increase in the global and national populations and the sophistication and variety of daily, leisure, and business activities in which modern populations regularly engage has reconfigured population distributions and transportation needs of the populations. Modern population distributions are characterized by densely populated cities that are associated with surrounding satellite regions of various types and usually evidence unparalleled growth in population density and geographical spread. The cities typically comprise a plurality of different regions characterized by different activities. The different regions may for example comprise a central transportation hub comprising a central train or bus station, high-density, high-rise residential zones, a financial district, a commercial downtown business district, shopping malls, and an entertainment district. Satellite regions of a city typically include residential areas inhabited by populations of various socioeconomic profiles, such as upscale suburbs, walled communities, rural and blue-collar suburbs, and all too often urban slums, and may include an airport and agricultural regions. The cities may themselves be part of a continuous urban or industrially developed area referred to as a “conurbation”. The various cities and satellite regions typically exhibit different diurnal, daily, monthly, and/or seasonal patterns of large and small, highly labile population movements into, out from, and within the regions, and inhabitants and visitors to the regions experience different transportation needs.

To serve the transportation needs of the “reconfigured” modern society, legacy mobility modes of transportation, such as active transport modes (walking and pedal bicycling), conventional public transportation systems (PTS), and privately owned vehicles, have been reinforced by a host of additional and varied, relatively new modes of transportation, and systems of making the new and legacy modes of transportation available to users. Today a modern mobility consumer may have available for use not only a privately owned vehicle, and a legacy public transport system (PTS), but various transport on demand (TOD) vehicles for hire such as taxis, limousines, buses, rickshaws and Jeepneys, and various types of personal dockless conveyances, such as e-bikes, e-scooters small dockless cars.

The density and ubiquity of the various modes of legacy and burgeoning new modes of transportation not only serve the needs of a modern population but also create new demands and burdens that stress the society that they serve and the environment in which they operate. Integrating and managing the various modes of transportation and associated mobility resources to serve the needs of society has led to understanding and managing the provision of transportation resources as mobility as a service (MaaS). Implementing the concept to provide a satisfactory quality of service (QoS) that answers the different mobility needs of society is a multivariate complex task.

### SUMMARY

An aspect of an embodiment of the disclosure relates to providing a MaaS management system, also referred to as “Moovit-Man”, for managing the provision of TOD vehicles to service demands of a population of users. Moovit-Man comprises executable instructions and/or data, hereinafter also referred to as software, required to provide functions that Moovit-Man provides a user, and comprises and/or has access to any of various processors, memories, and communications network entities and systems required to support Moovit-Man functions. Optionally Moovit-Man is at least partially cloud based and may comprises a cloud based, infrastructure of compute resources configured to support functions that Moovit-Man provides a user.

In an embodiment Moovit-Man comprises software executable to scan a geographical area of interest (GROI) and identify zones of interest (ZOIs) that exhibit transportation needs which may be serviced by and benefit from provision of TOD vehicles. A transportation need which may benefit from provision of TODs may by way of example be a time dependent need to reduce traffic congestion, a dearth of transportation options for a first or last mile service, or inadequate accessibility, for example as a result of meandering rather than direct routes, for physically reaching a location of desired goods, services or entertainment. Scanning to determine a ZOI in a GROI for a given transportation need optionally comprises determining a spatiotemporal geofence that bounds the ZOI as a spatiotemporal volume whose geographic shape and size may be time dependent, and within which the transportation need defining the ZOI may be considered to exist. Scale of time dependence of a spatiotemporal geofence may be hourly, daily, monthly, and/or seasonal. A geofence is a spatial cross section of a spatiotemporal geofence at a given time. Unless indicated explicitly or by context, reference to a geofence is considered to reference a temporal cross section of a spatiotemporal geofence.

In accordance with an embodiment, a ZOI geofence for a given transportation need may be determined heuristically and/or analytically. A heuristic geofence may be determined by adopting a neighborhood, municipal, administrative, or otherwise arbitrary boundary. An analytical ZOI geofence may be determined by processing a spatiotemporal service need feature (SNEF) vector comprising a component providing a geographic location, a component providing a time stamp, and at least one component that is a value of a metric which provides a measure indicative of the given transportation need. In an embodiment an analytical ZOI for a given transportation need may be determined by clustering SNEF vectors as a function of their respective locations, time stamps, and a feature or features indicative of the need. A ZOI geofence for the transportation need may be determined as a boundary of a spatiotemporal volume that encloses an inordinate concentration of the clustered SNEFs. In an embodiment processing a SNEF vector to determine a ZOI geofence may comprise tiling the GROI into a plurality of regular or irregular geographical tiles, “geotiles”, and evaluating for each of the geotiles the SNEF vector. The geofence may be substantially coincident with a geographic isoline of a function of the SNEF vector and/or a derivative of a function of the SNEF vector.

In an embodiment Moovit-Man comprises software for provisioning TOD vehicles to users in a determined ZOI based on a dynamic map, optionally referred to as a “tempest map”. A tempest map maps current locations of TOD vehicles in the GROI, or GROI to which the ZOI belongs, and determines distances between a current, source location, of a given TOD vehicle in the ZOI or GROI and a destination location for the given TOD vehicle, in accordance with a trip cost metric (TRICOM).

A TRICOM may be a function of at least one or any combination of more than one of: a beeline distance, BEE-ΔD, between the source and destination locations; a Manhattan distance, MAN-ΔD, between the source and target locations; a trip time, TR-ΔT, to navigate the Manhattan distance; a vehicle operating cost, TR-CST, incurred in making the trip; a measure of inconvenience, MI, caused by making the trip to current passengers of the TOD vehicle and/or reservation passengers, (passengers who are not currently on the TOD vehicle but have reserved a seat on the TOD vehicle); and/or a trip priority (TR-P). An MI may be determined based on at least one or any combination of more than one of added travel time for current passengers, additional delay in pick-up time of reservation passengers, and/or crowding of the TOD vehicle. A trip priority may by way of example be determined as a function of at least one or any combination of more than one of a destination location for a passenger pick-up, drop-off, or passenger profile. A location of a passenger pick-up, drop-off for a TOD vehicle is optionally referred to as a virtual stop.

In an embodiment Moovit-Man operates to determine QoS and/or effectiveness of a quantity and/or distribution of vehicles in a fleet of TOD vehicles made available to a ZOI in satisfying an identified transportation need associated with the ZOI. Effectiveness of the TOD fleet is optionally determined by monitoring and processing the SNEF feature vector used to identify the transportation need. For example, the SNEF vector may repeatedly be evaluated for geotiles in the ZOI to determine if changes in a component or components of the SNEF vector evaluated for a geotile or geotiles in the ZOI indicate that the transportation need is being satisfactorily alleviated by the TOD fleet. If the processed SNEF indicates that the traffic need is not responding as hoped for to the quantity and/or distribution of vehicles in the TOD fleet, the quantity and/or distribution of the vehicles may be changed.

In an embodiment, determined time dependent historical changes in the SNEF vector may be used by Moovit-Man to anticipate and undertake changes in the quantity and/or distribution of vehicles in the fleet of TOD vehicles to support satisfactory performance of the fleet in responding to the transportation need associated with the ZOI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale

FIG. 1A schematically shows a map of a neighborhood of Boston Massachusetts as an example GROI that is tiled with geotiles and exhibits a ZOI having a first-mile/last-mile transportation need, in accordance with an embodiment of the disclosure;

FIG. 1B shows a flow chart of a procedure that Moovit-Man may execute to identify the ZOI exhibiting the first/last mile need shown in FIG. 1A, in accordance with an embodiment of the disclosure;

FIG. 2A schematically shows a map of Boston Massachusetts and environs that exhibits a transportation need to improve, “boost”, transportation resources, and ZOIs determined for the transportation boosting need, in accordance with an embodiment of the disclosure;

FIG. 2B shows a flow chart of a procedure that Moovit-Man may execute to identify ZOIs in the Boston area shown in FIG. 2A that may exhibit a need to boost PTS resources, in accordance with an embodiment of the disclosure;

FIGS. 2C and 2D show a flow chart of a procedure that Moovit-Man may execute to determine whether the ZOIs identified in FIG. 2A by the procedure shown in the flow chart of FIG. 2B have transportation boosting (T-Boost) need, in accordance with an embodiment of the disclosure;

FIG. 3A schematically shows a service area established for providing TOD services to the first/last mile ZOI shown in FIG. 1A, in accordance with an embodiment of the disclosure;

FIG. 3B shows a flow chart of a procedure that Moovit-Man may execute to determine a service corridor for a ZOI, in accordance with an embodiment of the disclosure.

FIG. 3C schematically shows a distribution of TOD vehicles and TOD service corridors along which the TOD vehicles travel in the TOD service area service area shown in FIG. 3A, in accordance with an embodiment of the disclosure; and

FIG. 3D shows a now chart of a procedure that Moovit-Man may execute to assign a TOD vehicle to pick up a user at a virtual station, in accordance with an embodiment of the disclosure; and

### DETAILED DESCRIPTION

In the discussion, unless otherwise stated, adjectives such as “substantially” and “about” modifying a condition or relationship characteristic of a feature or features of an embodiment of the disclosure are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily a required configuration of a possible embodiment of the disclosure. Unless otherwise indicated, the word “or” in the description and claims is considered to be the inclusive “or” rather than the exclusive or, and indicates at least one of, or any combination of more than one of items it conjoins.

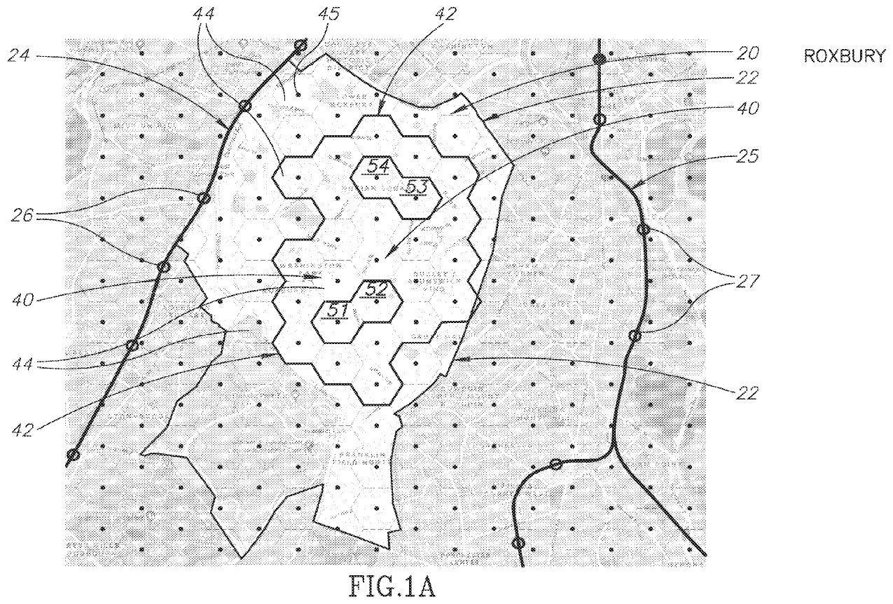

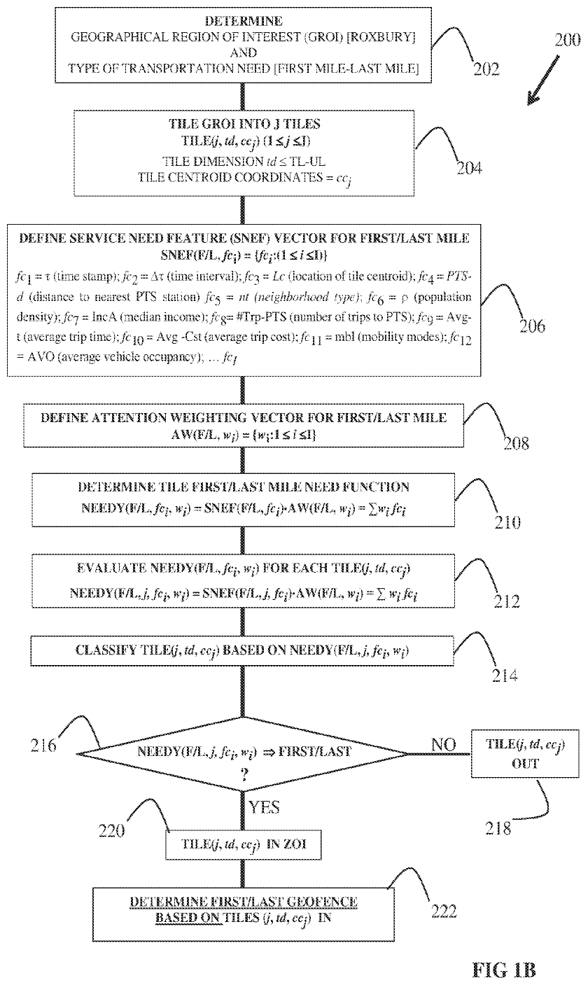

FIG. 1A schematically shows a map of a GROI 20 for which Moovit-Man has by way of example identified a ZOI 40 that exhibits a first-mile/last-mile transportation need and established a geofence 42 that delimits the ZOI, in accordance with an embodiment of the disclosure. GROI 20 is by way of example a neighborhood named, “Roxbury”, that is outlined by a municipal border 22 and is part of the greater Boston area. The greater Boston area, only a portion of which is shown in the figure, may be considered a larger GROI, an “envelope” GROI enclosing the smaller Roxbury GROI 20. Roxbury 20 is located between public transportation lines (PTS) 24 and 25 having PTS stations 26 and 27 respectively. In accordance with an embodiment Moovit-Man optionally identifies ZOI 40 and determines its associated geofence 42 by tiling a portion of the greater Boston area that includes Roxbury into a plurality of virtual tiles 44 and processing information for each of the tiles.

FIG. 1B shows a flow diagram 200 that illustrates a tiling procedure, also referred to by the label 200, that Moovit-Man may execute to determine ZOI 40 and geofence 42, in accordance with an embodiment of the disclosure.

In a block 202 of procedure 200 Moovit-Man receives a user request to determine if within a GROI 20 that is the neighborhood of Roxbury in the greater Boston area shown in FIG. 1A there exits a ZOI characterized by a first/last mile transportation need. In response, in a block 204 Moovit-Man tiles at least a portion of the greater Boston area including Roxbury with virtual tiles 44 schematically shown in FIG. 1A. Tiles 44 are optionally identical regular hexagons, with each tile having a perimeter delimiting a region of Boston at a location given by a location of a center 45 of the tile and a tile dimension td equal to distance between opposite sides of the tile.

Let a particular j-th tile 44 of a total of “J” tiles he represented by TILE(j,td,ccⱼ), also referred to as tileⱼ, where ccⱼ represents a geographic location of center 45 of the tile. Optionally td≤ULD where ULD is an upper limit distance that is considered to be a distance that most people would not consider to raise a last or first mile difficulty and would find reasonable to traverse by walking or using a dockless conveyance. By way of example ULD may be equal to about a half kilometer.

Optionally in a block 206 Moovit-Man determines a service need feature vector SNEF(F/L,j,fcᵢ)={fcᵢ:(1≤i≤I)} having features fcᵢ for determining whether a given TILE(j,td,ccⱼ) 44 indicates a first/last mile need. By way of example, the set {fcᵢ:(1≤i≤I)} may comprise at least one or any combination of more than one feature selected from:
fc₁=τ (a time stamp relevant to when features fcᵢ are evaluated for tile j);
fc₂=Δτ (duration of time interval during which features fcᵢ are evaluated);
fc₃=Lc (location of tile center);
fc₄=PTS-d (distance from Lc to a nearest PTS station);
fc₅=nt (where fc₁₁ represents a set of binary features that classify a tile as to neighborhood type, for example, residential, commercial, financial, industrial, rural);
fc₆=ρ (tile population density);
fc₇=IncA (population median income);
fc₈=#Trp-PTS (number of trips to PTS station);
fc₉=Avg-t (average trip time);
fc₁₀=Avg-Cst (average trip cost);
fc₁₁=TripModes (where fc₁₁ represents a set of mobility mode features, each mobility feature giving a fraction of trips to the PTS station given by fc₈ made using a particular different mode of transportation);
fc₁₂=AVO (fc₁₂ represents a set values giving an average vehicle occupancy for corresponding modes of transportation given by fc₁₁); and/or
. . .
fc_{I}.

In a block 208 Moovit-Man determines a first/last mile attention weighting vector AW(F/L, wᵢ)={wᵢ: 1≤i≤I) for which weights wᵢ determine a weight given to corresponding features fcᵢ in determining if a given tileⱼ indicates a first/last mile need. For example, population density fc₆ may be heavily weighted by a relatively large value for w₆ and a rural neighborhood in the set of neighborhood type features represented by fc₅ by a low weight w₅ for determining first/last mile need. Optionally, in a block 210 Moovit-Man defines a first/last mile need function NEEDY(F/L, j, fcᵢ, wᵢ) for a given tile j equal to the scalar product SNEF(F/L, j, fcᵢ)·AW(F/L, wᵢ)=Σwᵢfcᵢ. And in a block 212 evaluates SNEF(F/L, j, fcᵢ) for all tilesⱼ. Optionally, in a block 214, based on NEEDY(F/L, j,fcᵢ,wᵢ), Moovit-Man classifies TILE(j,td,ccⱼ) as indicating of not indicating a first/last mile need.

In a decision block 216, if TILE(j,td,ccⱼ) is classified in block 214 as not indicating a first/last mile need Moovit-Man may determine in a block 218 that the tile does not belong to first/last mile need ZOI 40 (FIG. 1A). On the other hand if TILE(j,td,ccⱼ) is classified in block 214 as indicating a first/last mile need, Moovit-Man includes TILE(j,td,ccⱼ) in ZOI 40. In a block 222 Moovit-Man optionally determines geofence 42 for ZOI 40 as a polygon that includes the areas of all TILE(j,td,ccⱼ)s determined in block 220 to belong to ZOI 40. It is noted that whereas an area within geofence 42 includes all TILE(j,td,ccⱼ)s determined to belong to ZOI 40 it may also include TILE(j,td,ccⱼ)s that are determined not to be part of ZOI 40. For example, TILE(j,td,ccⱼ)s individualized by labels 51, 52, 53, and 54 that are located within geofence 42 were determined in block 218 not to belong to ZOI 40.

Whereas in procedure 200 a TILE(j,td,ccⱼ) is classified as belonging or not belonging to ZOI 40 based on a function NEEDY(F/L,j,fcᵢ,wᵢ) that is a scalar product SNEF(F/L, j, fcᵢ)·AW(F/L, wᵢ), classifying a TILE(j,td,ccⱼ) as belonging or not belonging to a ZOI is not limited to determining and using a scalar product function such as NEEDY(F/L,j,fcᵢ,wᵢ). For example, a TILE(j,td,ccⱼ) may be classified as belonging to first/last mile ZOI 40 by a neural network that operates on the feature vector SNEF(F/L, j, fcᵢ) for the tile.

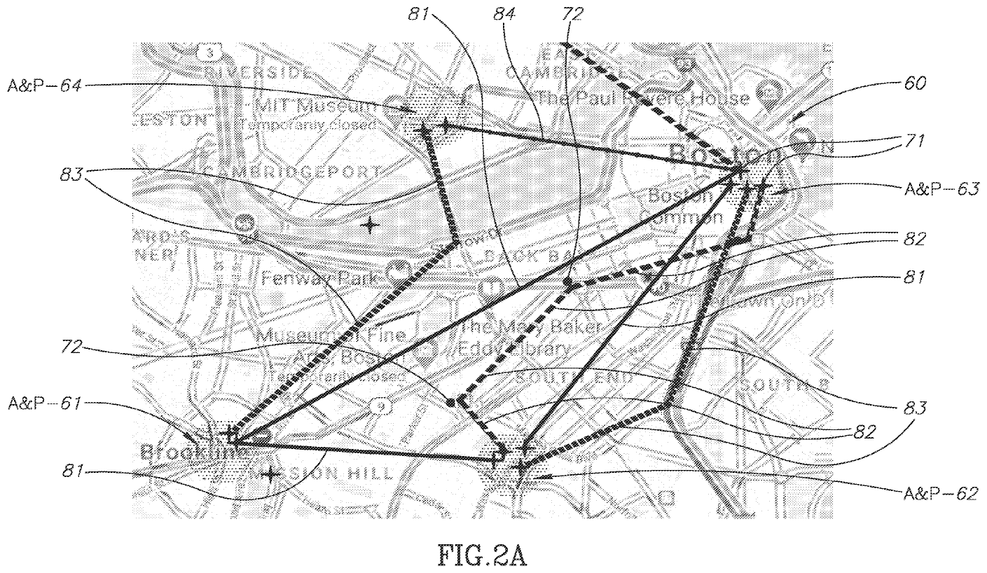

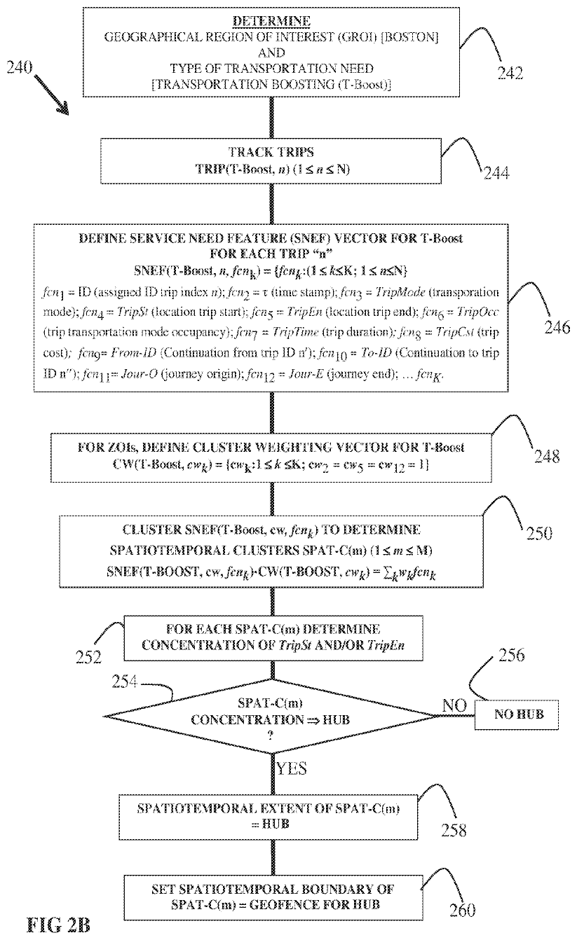

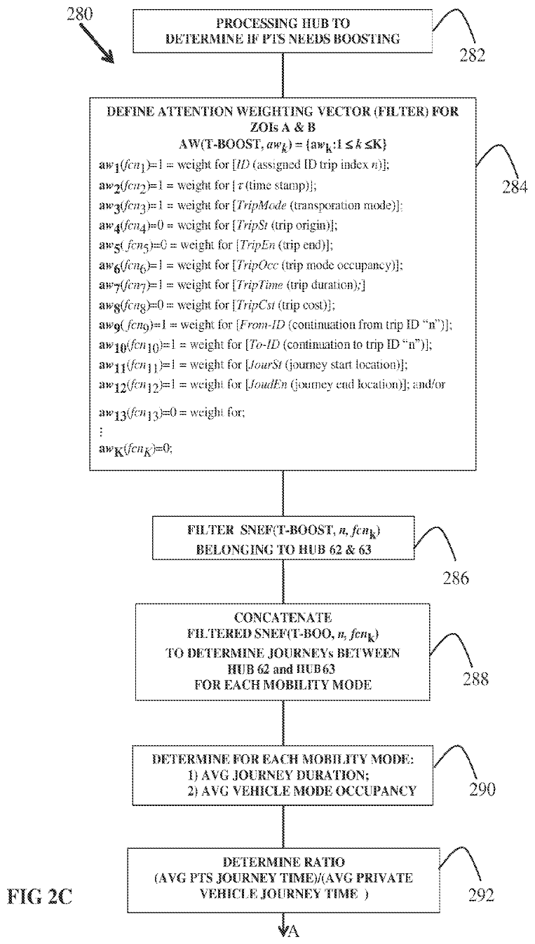

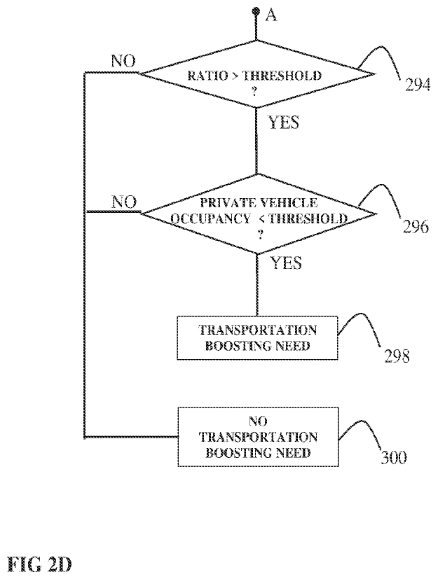

FIG. 2A schematically shows a map of a GROI 60 that is a portion of the greater Boston area for which, Moovit-Man identifies a plurality of ZOIs that are attraction and production transportation hubs characterized by a concentration of incoming and outgoing traffic. As discussed below Moovit-Man operates to determine whether the incoming and outcoming traffic indicates that PTS services available to the identified ZOIs are inadequate and in need of augmentation or “boosting” by additional transportation resources.

In FIG. 2A transportation hubs identified by Moovit-Man in accordance with an embodiment are indicated by stippled regions 61, 62, 63, and 64. Various modes of transportation that service trips and journeys between hubs 61, 62, 63, and 64 and respective routes travelled by the modes of transportation are indicated by different stylized lines. Locations at which a journey starts or ends are indicated by four-pointed star icons 71, and intermediate stops, also referred to as waystations, along a journey travel route between journey start and end locations are indicated by solid circles 72.

A journey is a travel instance undertaken between a first location, a journey start location, at which a person initiates traveling to reach a desired destination at a second location, a journey end location at which the desired destination is located. A journey may comprise a plurality of trips which are portions of the journey between two locations, one of which locations is a waystation, along the journey route. A waystation is a location at which a person making a journey pauses traveling, for example to change modes of travel, freshen up, or meet a traveling companion. Stylized lines, 81, 82, 83, and 84 in FIG. 2A represent travel by private vehicle, subway, bus, and cab respectively. An individual stylized line, 81, 82, 83, and 84 indicates a general direction of travel “as the crow flies” and not the actual street routes, which may appear quite different from the crow flies trajectory, of a plurality of trips or journeys made using the mode of transportation that the stylized line represents.

FIG. 2B shows a flow diagram 240 of a procedure, also referenced by numeral 240, by which Moovit-Man may identify and delimit attraction and production transportation hubs 61, 62, 63, and 64 shown in FIG. 2A, in accordance with an embodiment of the disclosure. FIGS. 2C and 2D show a flow diagram 280 of a procedure, also referred to by numeral 280, by which Moovit-Man may determine whether traffic to and from hubs 61, 62, 63, and 64 indicate transportation boosting needs, in accordance with an embodiment of the disclosure.

With reference to procedure 240 shown in FIG. 2B, in a block 242 Moovit-Man receives a request to identify and locate transportation hubs in the greater Boston area and determine whether traffic to and/or from the hubs indicate a need to boost transportation resources available to travel to and from the hubs. In response, optionally in a block 244 Moovit-Man operates to acquire data for a plurality of N trips TRIP(T-Boost, n) 1≤n≤N that are traveled in the greater Boston area for analysis to locate traffic hubs and determine a transportation “booster need” for the area, in accordance with an embodiment. Optionally in a block 246 Moovit-Man defines a SNEF feature vector SNEF(T-Boost, n, fcnₖ) having K components fcnₖ, 1≤k≤K that may be processed to identify traffic hubs and determine transportation booster (T-Boost) needs for the hubs. By way of example, a set {fcnₖ: 1≤k≤K} may include at least one or any combination of more than one feature selected from:
fcn₁=ID (assigned ID trip index n);
fcn₂=τ (time stamp);
fcn₃=TripMode (transportation mode: private vehicle, subway, bus, or cab;
fcn₄=TripSt (location trip start);
fcn₅=TripEn (location trip end);
fcn₆=TripOcc (trip transportation mode occupancy);
fcn₇=TripTime (trip duration);
fcn₈=TripCst (trip cost);
fcn₉=From-ID (continuation from trip ID “n”);
fcn₁₀=To-ID (continuation to trip ID “n”);
fcn₁₁=JourSt (journey start location);
fcn₁₂=JoudEn (journey end location); and/or
. . .
fcn_{K}.

Optionally in a block 248 Moovit-Man defines a cluster weighting vector CW(T-Boost, cwₖ)={cwₖ: 1≤k≤K}. For CW(T-Boost, cwₖ), optionally cw₂=cw₄=cw₅=cw₁₂=1 may be used to weight features in feature vectors SNEF(T-Boost, n, fcnₖ) for processing to cluster the feature vectors and identify transportation hubs in the greater Boston area. Optionally in a block 250, Moovit-Man generates a weighted feature vector for each trip TRIP(T-Boost, n) by multiplying, element by element components in SNEF(T-Boost, n, fcnₖ) by components in CW(T-Boost, cwₖ). In the block Moovit-Man may cluster the weighted feature vectors to determine spatiotemporal clusters SPAT-C(m) 1≤m≤M of trip start locations, fcn₄=TripSt, and/or trip end locations, fcn₅=TripEn.

In a block 252 Moovit-Man may determine a concentration of trip start locations (TripSt) and/or trip end locations (TripEn) and in a decision block 254 determines whether or not the concentration of trip start and/or end locations for a cluster SPAT-C(m) indicates that the cluster is a transportation hub. By way of example, a concentration of clustered trip start and/or end locations may indicate a hub if the concentration is greater than a predetermined threshold concentration. Alternatively, features of a cluster SPAT-C(m), such as a centroid, spatial spread, and/or a point cloud of trip start and end locations may be input to a neural network for processing to determine if the cluster warrants being considered a ZOI. If a hub is not indicated, optionally in a block 256 the SPAT-C(m) is not considered to be a ZOI. On the other hand, if the concentration does indicate a hub, optionally in a block 258 the spatiotemporal cluster SPAT-C(m) is considered to be a ZOI. In a block 260, Moovit-Man may determine a spatiotemporal geofence for the cluster and thereby the ZOI. Determining for the spatiotemporal geofence a geofence at a given time or time period may comprise determining a convex polygon for the trip start and/or end locations in the cluster.

With reference to procedure 280 shown in FIGS. 2C and 2D, Moovit-Man operates to determine if a ZOI 61, 62, 63, or 64 identified by procedure 240 shown in FIG. 2B exhibits a particular transportation need. In a block 282 Moovit-Man is directed to determine if a QoS provided by the PTS service of buses and subways in the Boston area shown in FIG. 2A is unsatisfactory and in need of boosting.

In a block 284 Moovit-Man may define an attention weighting vector AW(T-Boost, awₖ)={awₖ: 1≤k≤K} for weighting components of SNEF(T-Boost, n, fcnₖ), optionally determined by procedure 240, to determine if trips TRIP(T-Boost, n) associated with identified ZOIs 61, 62, 63, and/or 64 indicate a transportation boosting deficiency. By way of example, weighting components, awₖ, of AW(T-Boost, awₖ) for weighting corresponding components fcnₖ of SNEF(T-Boost, n, fcnₖ) may be assigned values:
aw₁(fcn₁)=1=weight for [ID (assigned ID trip index n)];
aw₂(fcn₂)=1=weight for [τ (time stamp)];
aw₃(fcn₃)=1=weight for [TripMode (transportation mode)];
aw₄(fcn₄)=0=weight for [TripSt (trip origin)],
aw₅(fcn₅)=0=weight for [TripEn (trip end)];
aw₆(fcn₆)=1=weight for [TripOcc (trip mode occupancy)];
aw₇(fcn₇)=1=weight for [TripTime (trip duration);]
aw₈(fcn₈)=0=weight for [TripCst (trip cost)];
aw₉(fcn₉)=1=weight for [From-ID (continuation from trip ID “n”)];
aw₁₀(fcn₁₀)=1=weight for [To-ID (continuation to trip ID “n”)],
aw₁₁(fcn₁₁)=1=weight for [JourSt (journey start location)];
aw₁₂(fcn₁₂)=1=weight for [JoudEn (journey end location)]; and/or
aw₁₃(fcn₁₃)=0=weight for; [symbol]
aw_{K}(fcn_{K})=0;

It is noted that weights aw₄(fcn₄)for TripSt (trip origin)], aw₅(fcn₅) for TripEn (trip end), and aw₈(fcn₈)for TripCst (trip cost)] are, by way of example, set to zero, TripSt and TripEn, and TripCst may not be pertinent for a particular trip if fcn₉ for From-ID, fcn₁₀ for To-ID , fcn₁₁ for JourSt, and fcn₁₂ for JourEn, which are weighted “1” in AW(T-Boost, awₖ) are known. And fcn₈ for TripCst (trip cost), while relevant for many different types of analysis of transportation needs may not be relevant for determining a boosting need.

In a block 286 Moovit-Man may filter SNEF(T-Boost, n, fcnₖ) to select for analysis data optionally related to TRIP(T-Boost, n)s, having a JourSt (journey start location) in ZOI 62 and a JourEn (journey end location) in ZOI 63 or a JourEn in ZOI 62 and a JourSt in ZOI 63. In a block 288 Moovit-Man uses values from selected SNEF(T-Boost, n, fcnₖ) vectors for ID trip indices n from components fcn₁, time stamps τ from components fcn₂, TripModes from fcn₂, from From-IDs from fcn₉, and To-IDs from fcn₁₀ to concatenate trips to provide transportation data for complete journeys between ZOI 62 and and ZOI 63. It is noted that a complete journey determined in block 288 may have been made using only a single mode of transportation or a mix of different modes of transportation.

Optionally in a block 290 Moovit-Man determines for each single mode and for mixed mode journeys between ZOI 62 and ZOI 63: 1) an average journey duration; and 2) an average vehicle occupancy. And in a block 292 Moovit-Man may determine a ratio between an average journey time for journeys between ZOI 62 and ZOI 63 made at least in part by a PTS vehicle divided by an average journey time for travel between ZOI 62 and ZOI 63 by private vehicle.

In a decision block 294, if the ratio determined in block 292 is less than a predetermined threshold Moovit-Man optionally proceeds to a block 300 and determines that PTS traffic between ZOI 62 and ZOI 63 does not exhibit a transportation boosting need. On the other hand, if in block 294 the ratio is greater than the predetermined threshold, Moovit-Man proceeds to a block 296 to determine whether vehicle occupancy for journeys between ZOI 62 and ZOI 63 made by private vehicles is less that a predetermined occupancy threshold. If the occupancy is not less than the predetermined occupancy threshold Moovit-Man proceeds to block 300 and determines that traffic between ZOI 62 and ZOI 63 does not exhibit a transportation boosting need. On the other hand, if in block 296 private vehicle occupancy is less than the occupancy threshold Moovit-Man may determine that traffic between ZOI 62 and ZOI 83 does exhibit a transportation boosting need.

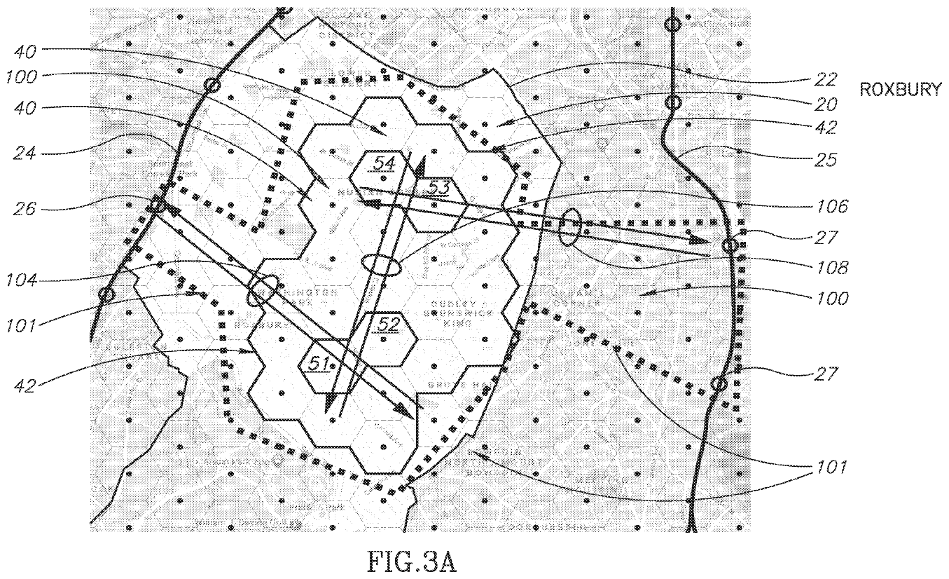

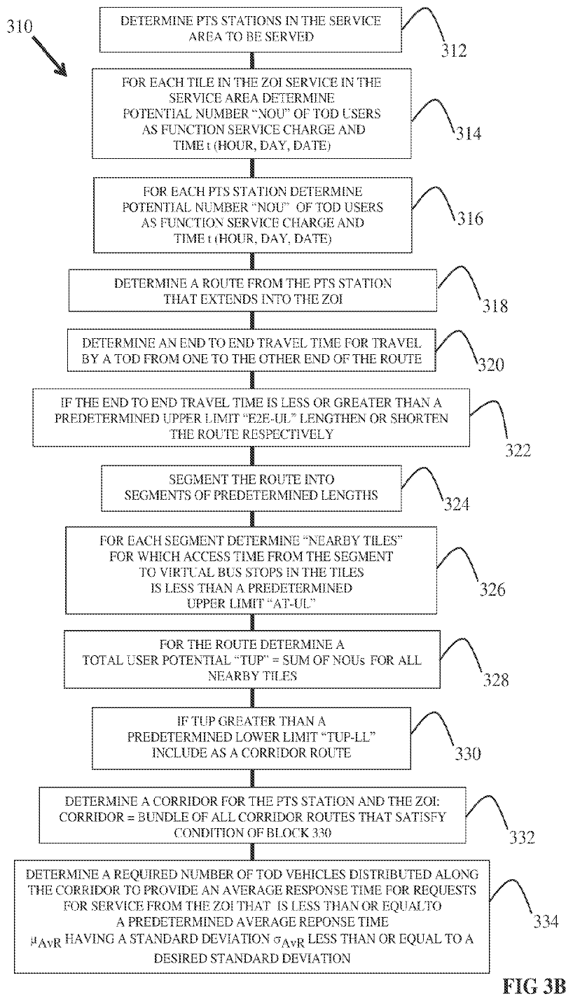

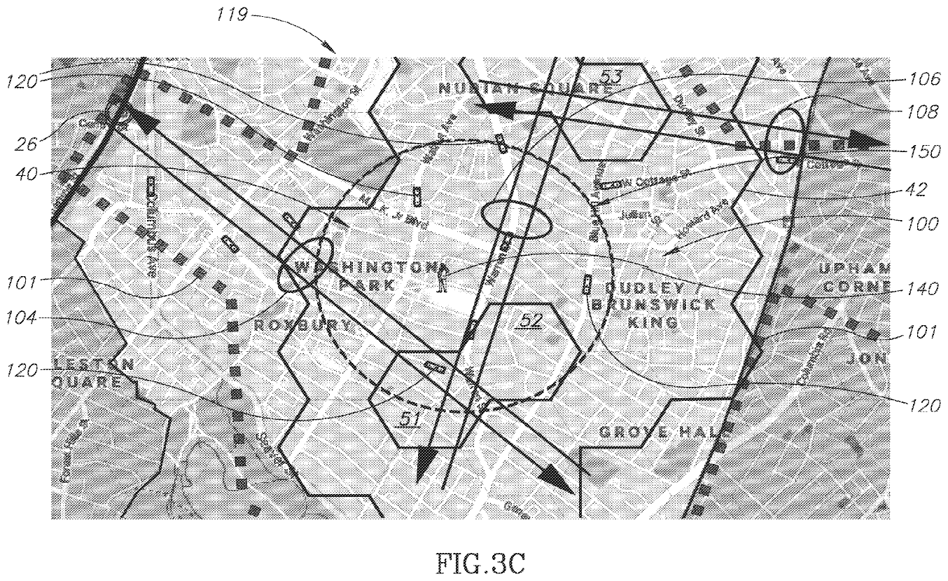

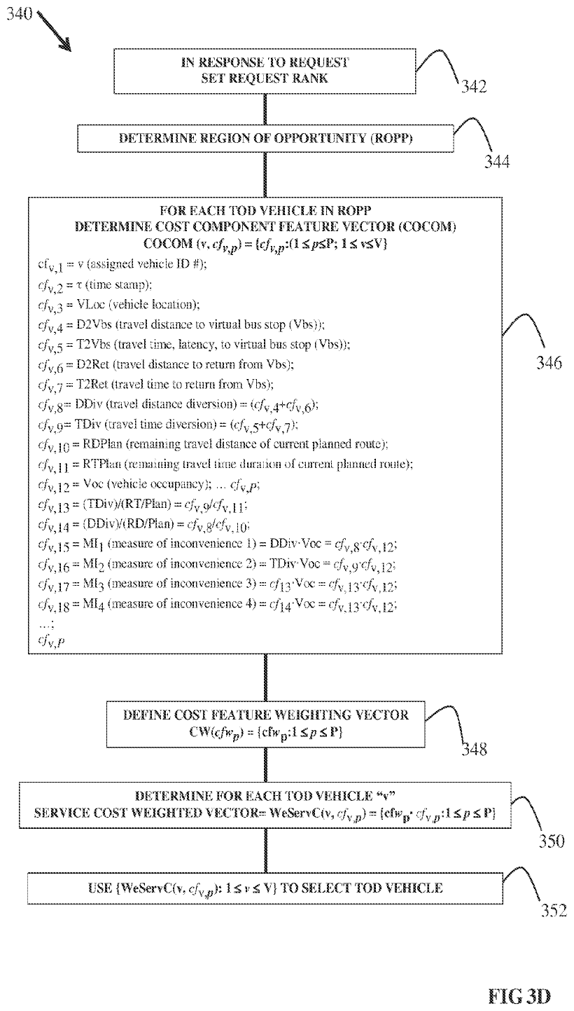

FIG. 3A schematically shows a service area 100 delimited by a service area boundary 101 established for providing TOD services to the first/last mile ZOI 40 shown in FIG. 1A, in accordance with an embodiment of the disclosure. TOD service area 100 includes ZOI 40 bounded by boundary 42 and optionally extends to include a PTS station 26 of PTS line 24 and two PTS stations 27 of PTS line 25. By way of example, service area 100 includes three TOD travel corridors 104, 106, and 108, schematically represented by oppositely directed arrows bundled by an ellipse. TOD vehicles deployed in service area 100 may travel back and forth along roadways in and along corridors 104 and 108 to provide first/last mile service to users in ZOI 40 for travel to and from PTS stations 26 and 27 in service area 100. TOD vehicles deployed in service area 100 may travel back and forth along roadways along corridor 106, which may also be referred to as an internal corridor, to provide first/last mile service to users in ZOI 40 for travel within ZOI 40 along major thoroughfares of the ZOI. In accordance with an embodiment travel corridors 104, 106, and 108, are configured to include and provide access to main thoroughfares that support relatively efficient, unobstructed movement of TOD vehicles and to be relatively close to concentrations of populations in ZOI 40 that use TOD services. By way of example Moovit-Man may determine corridors 104 or 108, which because the extend beyond ZOI 40 may be referred to as external corridors, for service area 100 and ZOI 40, m accordance with a procedure 310 shown in FIG. 3B.

In a block 312 of procedure 310 Moovit-Man may determine PTS stations for a service area to be served. In a block 314 for each tile in the ZOI service in the service area Moovit-Man optionally determines a potential number “NOU” of TOD users as function a service charge and time t (hour, day, date). Optionally in a block 316 for each PTS station Moovit-Man optionally determines a potential number NOU of TOD users as function service charge and time t (hour, day, date). In an embodiment, in a block 318 Moovit-Man determines a route from the PTS station that extends into the ZOI and in a block 320 may determine an end to end travel time for travel by a TOD from one to the other end of the route. In a block 322 if the end to end travel time is less or greater than a predetermined upper limit “E2E-UL” Moovit-Man may respectively lengthen or shorten the route and in a block 324 segments the route into segments of optionally predetermined lengths.

Optionally in a block 326 Moovit-Man determines for each segment “nearby tiles for which access time from the segment to virtual stops in the tiles is less than a predetermined upper limit “AT-UL” and proceeds to a block 328 to determine for the route a total user potential “TUP” equal to a sum of NOUs for all tiles determined to be “nearby”. In a block 330 if TUP greater than a predetermined lower limit “TUP-LL” the route is included as a corridor route. In an embodiment Moovit-Man determines a corridor for the PTS station and the ZOI that is optionally a bundle of all corridor routes for which the TUP is determined in block 330 to be a corridor route.

In a block 334 Moovit-Man optionally determines a number of TOD vehicles to be distributed along the corridor so that an average response time μ_{AvR} for requests for service from the ZOI is less than or equal to a predetermined advantageous average response time having a standard deviation σ_{AvR} less than or equal to a desired standard deviation.

Internal corridor 106 may be determined based on at least one attraction production hub internal to ZOI 40, heavily traveled thoroughfares in the ZOI, and/or or to provide connection to external corridors 104 and 108 using a procedure similar to that used to determine external corridors 104 and 108.

It is noted that in accordance with an embodiment of the disclosure the potential number of users, NOUs, of TOD services in a ZOI tile is time dependent. As a result, Moovit-Man may dynamically determine a number and geometry of corridors in a service area of a given ZOI, or quantifies or distributions of TOD vehicles along the corridors as functions of time. Optionally, Moovit-Man processes time resolved historic data characterizing NOUs to determine functions representing the NOUs in a ZOI as a function of time. In an embodiment Moovit-Man uses the functions to anticipate changes in demand for TOD services in the ZOI, and in response to an anticipated change may adjust at least one or any combination of more than one of a number of corridors determined for the ZOI, their respective geometries, or quantities or distributions of TOD vehicles associated with the corridors.

In accordance with an embodiment Moovit-Man uses a tempest map and an associated allocation algorithm to allocate TOD vehicles from a fleet of TOD vehicles 120 deployed to service users in ZOI 40. A tempest map optionally comprises for each TOD vehicle in the TOD fleet a substantially real time location of the vehicle, passenger occupancy, a current route that the TOD vehicle is intended to travel, and associated virtual stops at which the vehicle has been committed to stop to let off or take on passengers. By way of example, FIG. 3C schematically shows a tempest map 119 showing an enlarged portion of service area 100 shown in FIG. 3A and TOD vehicles 120 in the service area that are tracked by the tempest map, in accordance with an embodiment of the disclosure. A user at a virtual stop near the Washington Park area in ZOI 40 has requested that Moovit-Man provide a TOD vehicle 120 to take the user to PTS station 26 (FIG. 3A).

In response in user 140's request Moovit-Man operates to allocate a TOD vehicle 120 to take user 140 to PTS station 26 (FIG. 3A), optionally in accordance with an allocation procedure illustrated in a flow diagram 340 shown in FIG. 3D.

In a block 342 of allocation procedure 340 Moovit-Man optionally ranks user 140 as to whether or not the user is located in ZOI 40, and if the user is not within ZOI 40 ignores the request. It is noted that ZOI 40 does not include areas indicated by tiles 51, 52, 53, and 54. In a block 344 Moovit-Man may determine an, optionally circular, region of opportunity (ROPP) indicated by a circular dashed boundary 150 shown in FIG. 3B. In accordance with an embodiment of the disclosure Moovit-Man considers only TOD vehicles located within ROPP 150 as candidates for a TOD vehicle 120 to pick up user 140, and in a block 346 determines for each TOD vehicle in ROPP 150 a feature vector having cost components cfₚ (1≤p≤P) that may be used to determine a cost for the TOD vehicle 120 to service the user 140 request. In an embodiment a ROPP may be determined to have a geographic area containing vehicles that can reach user 140 within a predetermined upper limit delay time from a time at which the user made his or her request for a TOD vehicle. In an embodiment the ROPP may have an area constrained to include a number of TOD vehicles for which an amount of time or processing resources required to process the vehicles to select one of the vehicles to service user 140 is less than an advantageous maximum. Optionally, the advantageous maximum is determined by a load balancing constraint. Assuming that there are, “V”, TOD vehicles in ROPP 150, a cost component feature vector for a v-th TOD vehicle may be written,

COCOM(v, cf_{p,v})={cf_{p,v}:(1≤p≤P)}, where (1≤v≤V).

In an embodiment the set of COCOM(v, cf_{p,v}) cost components {cf_{p,v}:(1≤p≤P)} may comprise at least one or any combination of more than one of the following components:
cf_{v,1}=v (assigned vehicle ID #);
cf_{v,2}=τ (time stamp);
cf_{v,3}=VLoc (vehicle location);
cf_{v,4}=D2Vbs (travel distance to virtual stop (Vbs));
cf_{v,5}=T2Vbs (travel time, latency, to virtual stop (Vbs));
cf_{v,6}=D2Ret (travel distance to return from Vbs);
cf_{v,7}=T2Ret (travel time to return from Vbs);
cf_{v,8}=DDiv (travel distance diversion)=(cf_{v,4}+cf_{v,6});
cf_{v,9}=TDiv (travel time diversion)=(cf_{v,5}+cf_{v,7});
cf_{v,10}=RDPlan (remaining travel distance of current planned route);
cf_{v,11}=RTPlan (remaining travel time duration of current planned route);
cf_{v,12}=VoC (vehicle occupancy);
cf_{v,13}=(TDiv)/(RTPlan)=cf_{v,9}/cf_{v,11};
cf_{v,14}=(DDiv)/(RDPlan)=cf_{v,8}/cf_{v,10};
cf_{v,15}=MI₁ (measure of inconvenience 1)=DDiv·VoC=cf_{v,8}·cf_{v,12};
cf_{v,16}=MI₂ (measure of inconvenience 2)=TDiv·VoC=cf_{v,9}·cf_{v,12};
cf_{v,17}=MI₃ (measure of inconvenience 3)=cf₁₃·VoC=cf_{v,13}·cf_{v,12};
cf_{v,18}=MI₄ (measure of inconvenience 4)=cf₁₄·VoC=cf_{v,13}·cf_{v,12};
[symbol] ;
cf_{v,P-2}=QoS (Quality of Se vice
cf_{v,P-1}=PQoS (Perceived Quality of Service)
cf_{v,P}.

Optionally, in block 348 Moovit-Man defines a cost feature weighting vector, CW(cfwₚ)={cfwₚ: 1≤p≤P}, and in a block 350 optionally determines a service cost weighted vector WeServC(v, cf_{v,p}, cfwₚ) for each TOD vehicle “v”, where WeServC(v, cf_{v,p}, cfwₚ)={cf_{v,p}·cfwₚ: 1≤p≤P}. In a block 352 Moovit-Man uses the cost vectors WeServC(v, cf_{v,p}, cfwₚ) to select a TOD vehicle to pick up user 140 and bring the user to PTS station 26.

In using WeServC(v, cf_{v,p}, cfwₚ) to determine allocation of a vehicle for user 140 Moovit-Man may assign relatively large weight factors cfwₚ to measures of inconvenience such as at least one or any combination of more than one of MI₁, MI₂, MI₃, and/or MI₄. Costs associated with MI components are generally sensitive to a number of passengers inconvenienced by a deviation from a given TOD route plan and indicate an amplified cost if a relatively large number of TOD riders suffer a given inconvenience caused by the deviation. As a result, MI components may be heavily weighted so that empty TOD vehicles in ROPP 150 may be favored over occupied TOD vehicles in the ROPP for assignment to user 140. An MI is also expected to be sensitive to whether or not a user has been led to expect a particular feature of service provided by a TOD vehicle. In accordance with an embodiment Moovit-Man may therefore weight an MI associated with a given service feature with a larger weight if the given service feature has been assured. For example, an onboard passenger of a TOD vehicle who has been assured arrival at his or her destination by a given time is expected to be substantially more annoyed than if he or she had not been assured of the time of arrival. Moovit-Man may therefore weight cf_{v,16}=MI₂ (measure of inconvenience 2), which is responsive to an increase in travel time to planned virtual stops, with a substantially larger weight if an onboard passenger has been promised arrival at a destination by a given time than if the passenger had not been promised the time of arrival. Or an MI for a TOD vehicle that is a function of a cost component for example cf_{v,12}=VoC (vehicle occupancy), that affects crowding may be heavily weighted if a passenger has been promised seating adjacent an empty seat.

It is noted that whereas FIG. 3B shows, and the above discussion, refers to a single ROPP 150, practice of embodiments of the disclosure are not limited to a single ROPP to select a TOD to service a given client request. For example, Moovit-Man may define ROPPs of different sizes and or distances from a given virtual stop to assign vehicles as functions of vehicle occupancies VoC. For example for TOD vehicles occupied by smaller numbers of riders. Moovit-Man may define ROPPs that are larger than and/or farther from a given virtual stop than ROPPs for vehicles occupied by larger number of riders.

Using the cost vectors WeServC may comprise determining a scalar product CW(cfwₚ)·COCOM(v, cf_{p,v}) and selecting a TOD vehicle having a smallest scalar product to service user 140. Optionally, a neural network may be used to process vectors COCOM(v, cf_{p,v}) and/or WeServC(v, cf_{v,p}, cfwₚ) to select a TOD vehicle to serve the user.

There is therefore provided in accordance with an embodiment of the disclosure a method for managing a fleet of transportation on demand (TOD) vehicles, the method comprising: identifying a zone of interest (ZOI) responsive to a transportation need; determining a transportation on demand (TOD) service area that includes at least a portion of the ZOI; deploying a fleet of TOD vehicles in the service area to service the transportation need for the ZOI; tracking in real time the location in the service area of TOD vehicles in the TOD fleet; receiving a user request for a TOD vehicle from a user located in the ZOI; determining a neighborhood of the user location that comprises at least a portion of the ZOI; and selecting a TOD vehicle that belongs to the fleet and is located in the determined neighborhood to service the user request.

Selecting the TOD vehicle optionally, comprises determining a cost for each of at least one TOD vehicle in the neighborhood to service the user request and selecting the TOD vehicle based on the costs. Optionally, determining a cost for each vehicle of the at least one TOD vehicle comprises determining a real time cost feature vector for the TOD vehicle comprising cost components having values substantially current with the real tune that are useable to determine the cost. Optionally determining the cost comprises determining a weighting vector for the cost feature vector and using a component of the weighting vector to weight a component of the cost feature vector. Additionally, or alternatively determining the cost comprises determining a change in at least one or any combination of more than one of the cost feature vector components resulting from the TOD vehicle being assigned to service the user request. Determining the change may comprise determining a relative change with respect to a value for the cost component prior to assigning the TOD vehicle to service the user request.

In an embodiment determining the real time cost feature vector for the TOD vehicle comprises determining at least one measure of inconvenience (MI) component that provides a numerical measure of inconvenience expected to be experienced by an onboard passenger of the TOD vehicle resulting from the change in the at least one cost component. Optionally, the method comprises providing a greater numerical value for the at least one MI component if the change is a deviation from a value that the onboard passenger was led to expect.

In an embodiment determining the real time cost feature vector for the TOD vehicle comprises determining at least one measure of inconvenience (MI) component that provides a numerical measure of inconvenience expected to be experienced by the user resulting from the change in the at least one cost component. Optionally the method comprises providing a greater numerical value for the MI component of the feature vector experienced by the user if the change is a deviation from a value that the user was led to expect.

In an embodiment the numerical measure of inconvenience resulting from the change in at least one cost component is provided by a function of the at least one cost component determined responsive to data acquired by polling people that use TOD vehicles. In an embodiment the numerical measure of inconvenience resulting from the change in at least one cost component is provided by a function of the at least one cost component determined responsive to statistical data acquired from observation of behaviour of people that use TOD vehicles.

In an embodiment the at least one MI comprises an MI responsive to a measure of quality of service (QoS) that the TOD vehicle provides. In an embodiment the at least one MI comprises an MI responsive to a measure of perceived quality of service (PQoS) that the TOD vehicle generates.

In an embodiment selecting the TOD vehicle comprises minimizing a cost function that is a function of the cost feature vectors determined for each of the TOD vehicles in the neighborhood.

In an embodiment the cost components comprise at least one, or any combination of more than one, of a current location of the TOD vehicle, a current number of onboard passengers, a planned route that the TOD vehicle is currently assigned to travel from the current location, one or more virtual stops associated with the currently planned route at which the vehicle is assigned to let off a passenger of the on-board passengers, and/or one or more virtual stops along the currently planned route at which the TOD vehicle is planned to take on a passenger.

In an embodiment the method comprises determining for each TOD vehicle in the neighborhood a change in projected net revenue equal to an increase in gross revenue minus the cost resulting from the TOD vehicle being assigned to service the user request. Optionally selecting the TOD vehicle comprises selecting the TOD vehicle based on the projected net revenue. Optionally, selecting the TOD vehicle comprises determining an extremum of a cost function that is a function of the net revenues determined for each of the TOD vehicles in the neighborhood.

In an embodiment the method comprises constraining the selecting from changing a number of onboard passengers currently in a TOD vehicle in the neighborhood other than in the selected TOD vehicle in response to the selecting. In an embodiment the method comprises constraining the selecting from exchanging currently onboard passengers between TOD vehicles in the neighborhood in response to the selecting. In an embodiment selecting the TOD vehicle comprises changing a number of currently onboard passengers in at least one TOD vehicle in the neighborhood in addition to the selected TOD vehicle. In an embodiment selecting the TOD vehicle comprises exchanging currently onboard passengers between TOD vehicles in the neighborhood. In an embodiment selecting the TOD vehicle comprises changing a virtual stop at which at least one vehicle in the neighborhood is assigned to pick up a passenger.

In an embodiment determining the neighborhood comprises determining a constraint on a number of vehicles contained in a geographical area of the neighborhood and determining an area of the neighborhood that satisfies the constraint. Optionally, the constraint requires that the number of vehicles in the neighborhood be less than a number of vehicles for which an amount of processing capacity required to process the number of vehicles to select a vehicle to service the request is less than an advantageous maximum. Optionally, the advantageous maximum is determined responsive to load balancing constraints. Optionally, the advantageous maximum is determined responsive to a predetermined upper limit. In an embodiment determining the neighborhood comprises determining an upper limit on a delay from a time of receipt of the user request and a time at which the selected TODD vehicle reaches the user. In an embodiment wherein the neighborhood comprises the ZOI.

The method according to any of the preceding claims and monitoring traffic conditions in the ZOI. Optionally, subsequent to selecting the TOD vehicle comprising selecting a different TOD to service the user request responsive to a change in the monitored traffic conditions. The change in traffic conditions may comprise a change in traffic conditions along a planned route of travel for the TOD vehicle and/or the different TOD vehicle.

Descriptions of embodiments are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are, provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the invention is limited only by the claims.

1-33. (canceled)

34. A non-transitory computer-readable medium including instructions that when executed by at least one processor cause the at least one processor to perform operations for managing a fleet of transportation-on-demand vehicles, the operations comprising:
determining a plurality of service need feature vectors for a geographical region of interest, the plurality of service need feature vectors being associated with a plurality of transportation needs, wherein each service need feature vector includes components associated with: at least one of the transportation needs, a transportation time, and a location within the geographical region of interest;
identifying, based on the components, at least one cluster including a portion of the plurality of service need feature vectors and associated at least with a specific one of the plurality of transportation needs;
for the at least one identified cluster, identifying an associated spatiotemporal zone of interest in the geographical region of interest associated with the specific transportation need;
deploying at least a portion of the fleet of transportation-on-demand vehicles for the identified spatiotemporal zone of interest to service the associated specific transportation need;
tracking locations of the deployed transportation-on-demand vehicles for the spatiotemporal identified zones of interest;
receiving a request associated with a user location in the spatiotemporal zone of interest for a transportation-on-demand vehicle; and
selecting one of the deployed transportation-on-demand vehicles to service the request based on the location of the selected transportation-on-demand vehicle.

35. The computer-readable medium of claim 34, the operations further comprising determining a neighborhood for the user location including at least a portion of the spatiotemporal zone of interest, wherein the deployed transportation-on-demand vehicles is selected based on the location of the transportation-on-demand vehicle being within the neighborhood.

36. The computer-readable medium of claim 35, wherein the neighborhood is determined to satisfy a constraint on a number of vehicles contained in the neighborhood.

37. The computer-readable medium of claim 36, wherein the constraint corresponds to a processing capacity associated with selecting the transportation-on-demand vehicle to service the request.

38. The computer-readable medium of claim 37, wherein the constraint is associated with load balancing the processing capacity.

39. The computer-readable medium of claim 35, wherein the neighborhood is determined based on a delay from receiving the request until the selected transportation-on-demand vehicle reaches a user.

40. The computer-readable medium of claim 34, the operations further comprising determining a service area including the spatiotemporal zone of interest and at least one corridor to a public transportation station, wherein deploying at least a portion of the fleet of transportation-on-demand vehicles for the identified spatiotemporal zone of interest includes deploying the transportation-on-demand vehicles in the service area.

41. The computer-readable medium of claim 34, the operations further comprising, for each deployed transportation-on-demand vehicle, determining a cost associated with servicing the request, wherein the selecting is further based on the determined cost.

42. The computer-readable medium of claim 41, the operations further comprising determining a weight, wherein determining the cost includes applying the weight to at least one component of the cost.

43. The computer-readable medium of claim 42, wherein the at least one component of the cost is associated with at least one of a vehicle location, a number of onboard passengers, a characteristic of an assigned route, or at least one virtual stop associated with letting off or picking up a passenger.

44. The computer-readable medium of claim 42, the operations further comprising determining a change in at least one component of the cost resulting from selecting the deployed transportation-on-demand vehicle to service the user request, and determining at least one measure of inconvenience associated with the change.

45. The computer-readable medium of claim 44, wherein the change is relative to a value of the at least one component of the cost prior to selecting the deployed transportation-on-demand vehicle to service the request.

46. The computer-readable medium of claim 44, the operations further comprising increasing the at least one measure of inconvenience when the change deviates from an expected cost.

47. The computer-readable medium of claim 44, wherein the at least one measure of inconvenience is associated with at least one of an onboard passenger of the selected transportation-on-demand vehicle or a user associated with the request.

48. The computer-readable medium of claim 44, wherein the at least one measure of inconvenience is based on polling users of the fleet of transportation-on-demand vehicles.

49. The computer-readable medium of claim 44, wherein the at least one numerical measure of inconvenience is based on observed behavior of users of the fleet of transportation-on-demand vehicles.

50. The computer-readable medium of claim 44, wherein the at least one numerical measure of inconvenience corresponds to a quality of service associated with the selected transportation-on-demand vehicle.

51. The computer-readable medium of claim 42, the operations further comprising determining for each transportation-on-demand vehicle in the spatiotemporal zone of interest a change in projected net revenue associated with a gross revenue and the cost, wherein the transportation-on-demand vehicle is selected based on the projected net revenue.

52. The computer-readable medium of claim 34, the operations further comprising constraining the selecting of the transportation-on-demand vehicle from changing a number of passengers onboard another transportation-on-demand vehicle located in the spatiotemporal zone of interest, different than the selected transportation-on-demand vehicle.

53. The computer-readable medium of claim 34, the operations further comprising constraining the selecting of the transportation-on-demand vehicle from exchanging at least one onboard passenger between two deployed transportation-on-demand vehicles in the spatiotemporal zone of interest.

54. The computer-readable medium of claim 34, the operations further comprising changing a number of passengers onboard at least one of the transportation-on-demand vehicles deployed in the spatiotemporal zone of interest, different than the selected transportation-on-demand vehicle.

55. The computer-readable medium of claim 34, the operations further comprising exchanging at least one onboard passenger between two deployed transportation-on-demand vehicles in the spatiotemporal zone of interest.

56. The computer-readable medium of claim 34, the operations further comprising changing a virtual stop associated with picking up a passenger by one of the transportation-on-demand vehicles deployed in the spatiotemporal zone of interest.

57. The computer-readable medium of claim 34, the operations further comprising monitoring traffic in the spatiotemporal zone of interest, wherein selecting the transportation-on-demand vehicle is based on the traffic.

58. The computer-readable medium of claim 57, wherein the traffic is monitored along a planned route of travel associated with servicing the request.
